(19) United States
(12) Patent Application Publication
(10) Pub. No.: US 2014/0258316 A1
(43) Pub. Date: Sep. 11, 2014

(54) System and Method for Content Assessment

(71) Applicant: Open Text S.A., Luxembourg (LU)

(72) Inventors: Paul O'Hagan, Brooklin (CA); Valery Bachinsky, Aurora (CA)

(73) Assignee: Open Text S.A., Luxembourg (LU)

(21) Appl. No.: 14/200,741

(22) Filed: Mar. 7, 2014

Related U.S. Application Data
(60) Provisional application No. 61/775,227, filed on Mar. 8, 2013.

(51) Int. Cl. G06F 17/30

(52) U.S. Cl. CPC G06F 17/30595
USPC 707/756

(57) ABSTRACT

Embodiments of content assessment systems are provided herein. A content assessment system may gather metadata of content objects and process the content objects to extract targeted content of interest from the unstructured content of the content objects or to provide an indication of the content objects that include the target content of interest. The metadata and target content of interest can be stored as structured data in a content assessment repository. The structured content assessment data can be accessed to identify content assets for processing including migration of content assets.

### RELATED APPLICATIONS

This application claims the benefit of priority under 35 U.S.C. §119(e) to U.S. Provisional Patent Application No. 61/775,227, filed Mar. 8, 2013, entitled “System and Method for Content Assessment,” by O'Hagan et al., which is hereby incorporated by reference in its entirety for all purposes.

### TECHNICAL FIELD

This disclosure relates generally to the field of data management. More particularly, this disclosure relates to systems and methods for identifying content objects of interest. Even more particularly, this disclosure relates to profiling structured and unstructured content of content objects to identify content of interest for further processes.

### BACKGROUND

Organizations struggle with understanding the value and relevance of information within the vast quantities of content stored in shared drives and other repositories. Often, there is little to no control over what content is stored or for how long. Consequently, valuable content may be lost and information mishandled.

Traditional approaches to bringing understanding and control to large content repositories use full-text indexing technology to index the content and metadata attributes, thereby enabling topic experts the ability to identify content objects through traditional text searches or Regular Expression (regex) type queries.

Full-text indexing poses several difficulties. First, indexing vast volumes of content large investments in infrastructure to host the index. Second, the time it takes to create the index is frequently measured in weeks or months. Third, in order for other processes to identify documents of interest, the document repository must be searched using the full text index, which can be a time consuming process.

### SUMMARY

Embodiments of systems and methods for content assessment and transfer are disclosed herein. In particular, certain embodiments include a content assessment system that processes content objects and associated metadata to create a profile of the content objects in a structured format. For a set of content objects, a content assessment system can gather metadata for the content objects and process the unstructured content of the content objects to extract targeted content of interest from the unstructured content. The target content of interest may be any of the unstructured content that matches a specific piece of content or that qualifies as content of interest under a rule, such as a pattern matching rule. The metadata and target content of interest (or an indication that a content object contains a target content of interest) can be stored as structured data that can be used to identify content objects of interest for subsequent processes such as mass data transfers, reporting and other processes.

One embodiment of a content assessment system may include a metadata processing module configured to gather metadata of content objects stored in a source repository and to store the metadata of the content objects as structured data in a content assessment repository. The content assessment system may further include a content analytics module configured to process unstructured content of the content objects to automatically extract targeted content of interest from the unstructured content and to store the targeted content of interest as structured data in the content assessment repository. Thus, the content assessment system may store gathered metadata and target content data of interest as content assessment data in a structured form, even if some of the content assessment data is extracted from unstructured data.

The content assessment repository may comprise a relational content assessment database having a schema. In one embodiment the schema may be a normalized relational schema encompassing file system metadata, advanced document property information, and specific target information of interest. The metadata of the content objects may be stored as structured data in a set of metadata fields of the relational content assessment database and the targeted content of interest as structured data in a targeted content field of the relational content assessment database. The targeted content of interest and metadata for a content object may be stored in related fields corresponding to a particular content object in the relational content assessment database.

A content assessment system may further include a transfer module that is configured to identify a subset of content objects for transfer to a target repository based on the content assessment repository and transfer the identified content objects from a source repository to a target repository. The transfer module may map the gathered metadata for the subset of content objects from the content assessment repository to target repository metadata. The transfer module may further map target content of interest for the subset of content objects to target repository metadata.

Content objects of interest may also be quickly and easily identified for subsequent processing, such as passing content objects to an existing process or workflow, decommissioning or deleting content objects, performing in-place records management operations and performing other processes. Embodiments as disclosed provide an advantage by providing systems and methods that allow for the identification of content objects of interest without the time and resource requirements a full-text indexing process.

### BRIEF DESCRIPTION OF THE DRAWINGS

The drawings accompanying and forming part of this specification are included to depict certain aspects of content assessment. A clearer impression of content assessment, and of the components and operation of systems provided with content assessment, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts an embodiment of a content profiling and transfer architecture.

FIG. 2 depicts another embodiment of a content profiling and transfer architecture.

FIG. 3 is a functional block diagram of one embodiment of an architecture for processing content objects.

FIG. 4 is a functional block diagram of another embodiment of an architecture for processing content objects.

FIG. 5 is a diagrammatic representation of one embodiment structured content assessment data.

FIG. 6 is a diagrammatic representation of one embodiment of a structured content assessment data schema.

FIG. 7 is a diagrammatic representation of another embodiment of a structured content assessment data schema.

FIG. 8 is a diagrammatic representation of another of a structured content assessment data schema.

FIG. 9 is a diagrammatic representation of one embodiment of another structured content assessment data schema.

FIG. 10 is a flow chart illustrating one embodiment of a method for content assessment.

FIG. 11 is a flow chart illustrating another embodiment of a method for content assessment.

FIG. 12 is a flow chart illustrating one embodiment of a method for content assessment when a content object cannot be opened.

FIG. 13 is a flow chart depicting one embodiment of a method for transferring content objects from a source repository to a target repository.

FIG. 14 depicts one embodiment of a content integration architecture.

FIG. 15 depicts one embodiment of a content assessment and transfer architecture.

### DETAILED DESCRIPTION

Systems and methods for content assessment and transfer and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the systems and methods, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented using suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Some embodiments may be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at a mass storage device (e.g., a hard drive (“HD”)), and one or more input/output (“I/O”) device(s). The I/O devices can include a keyboard, monitor, printer, electronic pointing device (for example, mouse, trackball, stylus, etc.), or the like. In certain embodiments, the computer has access to at least one database locally or over the network.

ROM, RAM, and HD are computer memories for storing computer-executable instructions executable by the CPU or capable of being compiled or interpreted to be executable by the CPU. Within this disclosure, the term “computer readable medium” is not limited to ROM, RAM, and HD and can include any type of non-transitory data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented by programmed logic executing suitable computer-executable instructions that may reside on a computer readable medium (for example, a disk, CD-ROM, a memory, etc.). Computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, or any other programming or scripting code. Other software/hardware/network architectures may be used. For example, the functions of embodiments may be implemented on one computer or shared or distributed among two or more computers across a network. In one embodiment, the functions of embodiments may be distributed in the network. Communications between computers implementing embodiments of the invention can be accomplished using any electronic, optical, radio frequency signals, or other suitable methods and tools of communication in compliance with network protocols.

It will be understood for purposes of this disclosure that a service or module is one or more computer devices, configured (e.g., by a computer process or hardware) to perform one or more functions. A service may present one or more interfaces which can be utilized to access these functions. Such interfaces include APIs, interfaces presented for a web services, web pages, remote procedure calls, remote method invocation, etc.

Before discussing specific embodiments, a brief overview of the context of the disclosure may be helpful. Individuals and enterprises often need to track the documents and records that contain specific types of information or specific pieces of information. As an example, an entity may wish to track all documents or records containing entity specific metadata, such as customer numbers, project codes and the like. As the amount of data stored grows, it becomes increasingly time consuming to identify the relevant documents and records.

One way to identify documents and records is to create a search index that contains a list of keywords and related data that point to the documents that contain the keywords. In order to identify documents of interest, a keyword search is performed. In general, a user submits a query containing keywords, the keyword index is searched and the documents associated with the keywords in the index are identified as being relevant to the search.

Indexing, however, has limitations. An index will typically contain keywords that are not relevant to identifying documents for specific tracking purposes. For example, an entity wishing to track documents that contain specific project codes may have a search index that includes a large number of keywords to facilitate full text searching of the documents. In this case, the index contains a large amount of information that, while useful for performing searches, may be irrelevant to the entity's reasons for tracking documents containing project codes. Thus, the traditional search index may consume unnecessary storage resources. Furthermore, managing the index objects is often resource intensive.

Moreover, building an index can be time consuming and of limited usefulness. An index for a large amount of data may take weeks or months to construct. This can be problematic as it may delay reporting or compliance processes. For example, if an entity has a large number of un-indexed documents, it may be several weeks or months before the entity is able to search for documents containing information of interest. Furthermore, the entity may be limited to using regular expression searches which will require the entity to explicitly search for each discrete piece of information (e.g., search for each credit card number).

Systems and methods for content assessment allow content objects relevant to particular processes to be quickly and easily identified. As will be discussed in more detail below, a content assessment system can be configured to process content objects, extract data and populate a content assessment repository in a structured format so as to allow identification of content objects that may be relevant for one or more purposes. For content objects being assessed, a content assessment system can gather metadata for the content objects and process the unstructured data of the content objects to extract target content of interest. The metadata and target content can be stored in the structured format, enabling identification of content objects of interest based on explicit metadata as well extracted data from content objects.

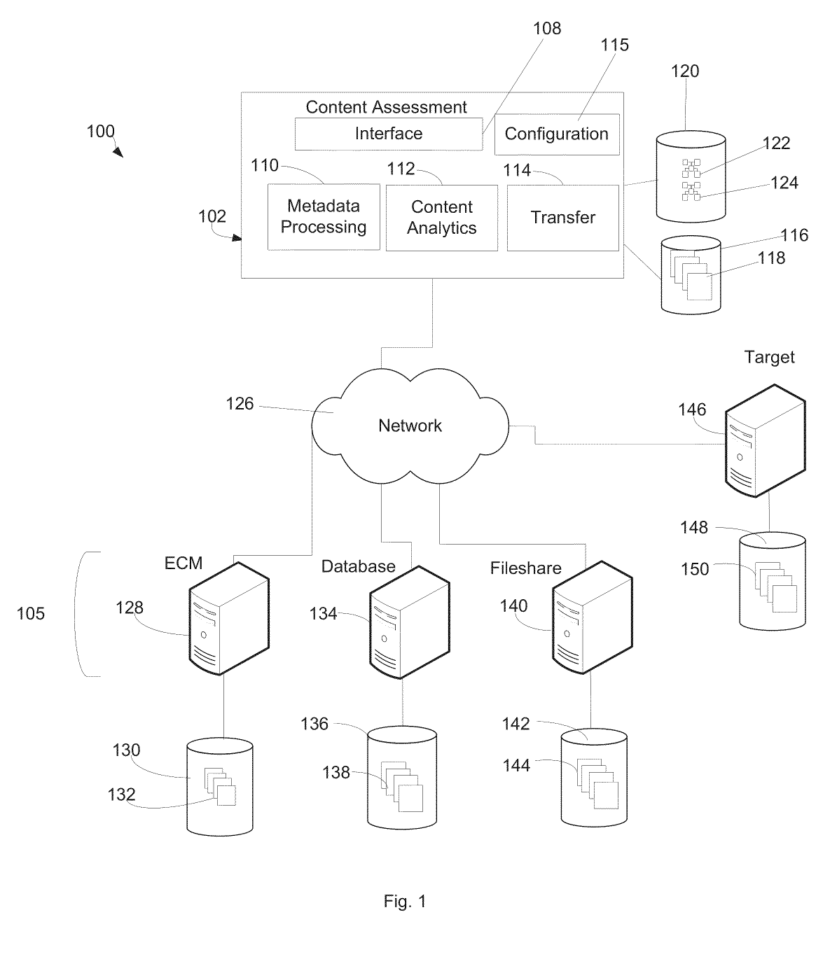

Turning now to FIG. 1, one embodiment of a content profiling and transfer system 100 for profiling data objects in source data stores and transferring content objects to a target data store is depicted. Content profiling and transfer system 100 includes a content assessment system 102, source repository systems 105 and target repository system 146 communicating via a network 126, which may be, for example, the Internet, an internet, an intranet, a LAN a WAN, an IP based network, etc. These communications may be accomplished according to one or more protocols such as, for example, HTTP or SOAP and in one or more formats.

Source repository systems 105 may include any number of different types of source repository systems, including, but not limited to an Enterprise Content Management (ECM) system 128 managing an ECM data store 130 storing ECM content objects 132, a database system 134 managing a database data store 136 storing database content objects 138 and a network file server 140 having a file share data store 142 storing file share content objects 144. Target repository system 146 may include any suitable repository system including, but not limited to, an ECM system, a database system or a file server managing a data store 148. The content objects stored in the source repository data stores may include files, records and other data structures. Target repository system 146 may store content objects copied or moved from source data stores as content objects 150. Content assessment system 102 can include a local repository 116 that can store local content objects 118. Local repository 116 may be a source repository, a target repository or an intermediate repository storing content objects during content profiling.

Content assessment system 102 can comprise one or more computing devices configured to gather metadata of source content objects, extract target content of interest from the unstructured data of the source content objects (or determine if the source content objects include the target content of interest) and store the metadata and target content of interest (or indication of the target content of interest) as structured content assessment data. Accordingly, content assessment system 102 may include a content assessment repository 120 (e.g., such as structured content assessment data 122 and structured content assessment data 124). Content assessment repository may be a network accessible repository, such as a network accessible database managed by a database server, or may be a local repository. Local repository 116 and content assessment repository 120 may share the same storage media or may use different storage media.

Content assessment system 102 includes a system metadata processing module 110. System metadata processing module 110 gathers all or selected metadata associated with a content object. System metadata processing module 110 may populate these properties into one or more structured forms or tables stored in the content assessment repository 120.

The metadata gathered may depend on the MIME type of the content object and can include regular file attributes and extended file attributes. The metadata gathered may include metadata associated with, for example, “file properties” of documents from word processors, presentation software, spreadsheets, publishing software, and the like, and may correspond to Date, Name, Location, Access Control Lists, and other metadata. The metadata gathered may include the types of metadata automatically generated upon creation or modification of a document or metadata that was manually entered and associated with a content object by a user.

Content assessment system 102 further includes content analytics module 112. Content analytics module 112 is configured to open a content object and examine its contents to identify content of interest. Content analytics module 112 may be preconfigured and/or customized to identify and extract particular information from a content object, such as a word processing document, form, spreadsheet, database record or other document or object. In some embodiments, for example, this information can include specified target content of interest to particular organizations or other entities, such as Names, Phone Numbers, Passports, Credit Cards, Customer IDs, project codes and the like.

More particularly, in one embodiment, the content analytics module 112 may be configured to examine a document to determine if the document contains content matching a specific piece of content (e.g., specific project codes, credit card numbers, etc.) or content that matches a specific rule (e.g., content that matches a project code pattern, content that matches a credit card pattern, etc.) If such content is found, the content analytics module 112 may determine that the document contains target content of interest. Content analytics module 112 may populate an entry in the content assessment database for content object with the target content interest or with an indication that the content object contains the target content of interest.

System metadata processing module 110 and content analytics module 112 create a profile of content objects by populating content assessment repository 120 to create a set of structured content assessment data (e.g., structured content assessment data 122). System metadata processing module 110 and content analytics module 112 may populate structured content assessment data 122 with entries for content objects whether or not the content objects contain the target information of interest or only with entries for content objects that contain the target information of interest.

Content assessment system 102 further includes transfer module 114. Transfer module 114 is configured to identify content objects for transfer from the structured content assessment data and move or copy identified content objects to target repository system 146. This may include moving or copying content objects in a mass move or copy operation. Objects from multiple source repositories may be transferred to target repository system 146. Thus, for example, target content objects 150 may comprise copies of ECM content objects 132, database content objects 138 and file share content objects 144 transferred to target data store 148. Transfer module 114 may also process rules to map structured content assessment data to metadata of target repository system 146.

Content assessment system 102 further comprises an interface module 108. Interface module 108 can provide a user interface to allow a programmatic or human user to provide information to content assessment system. According to one embodiment, for example, a user may define a content assessment project, specifying the criteria for content objects to evaluate (such as location, file types or other criteria), the metadata to gather, the target content of interest, connection information, target repository information, mapping rules and other parameters. Executing a project may result in a set of structured content assessment data associated with that project. Thus, for example, structured content assessment data 122 may relate to a first project and structured content assessment data 124 may relate to a second project. In other embodiments, the results of multiple projects may be stored in the same set of structured content assessment data.

Content assessment system 102 may include a set of configuration information 115. Configuration information 115 can include information used to connect to source repository systems 105, target repository system 146 and content assessment repository 120, the location of content objects to profile, the location to which to transfer content objects, information used to configure a set of structured content assessment data and other information. Configuration information 115 may further include rules regarding the metadata to gather and rules regarding the target content of interest to extract. The rules for target content of interest may include a listing of content to match, for example a listing of credit card numbers to find, or a pattern to match, such as a pattern used to identify credit card numbers.

Content assessment data can be stored in any suitable structured manner. According to one embodiment, content assessment repository 120 comprises a relational database storing structured content assessment data. The structured content assessment data may be stored according to any suitable schema. According to one embodiment, the schema may be a normalized relational schema encompassing file system metadata, advanced document property information, and specific targeted content of interest or other schema.

In operation, content assessment system 102 accesses configuration information 115 to determine the location(s) and characteristics of content objects to profile. Content assessment system 102 connects to the appropriate source repository system 105 or local repository and interfaces with the repository to identify content objects meeting the criteria. Content assessment system 102 may identify content objects in the source repository system or local repository to profile based on MIME type, location or other criteria. For example, configuration data 115 may specify that content assessment system is to profile content objects in ECM data store 130 and in a particular directory of file share data store 142. In this example, content assessment system 102 can connect to ECM system 128 and poll ECM system 128 for a listing of ECM content objects 132 available. Content assessment system can also connect to network file server 140 to scan the specified directory location for content objects 144 in the directory.

In some cases, the content objects available to content assessment system 102 for profiling may be limited by the credentials of content assessment system 102 with the source repository. Additionally, if content assessment system 102 is only configured to process certain MIME types, content assessment system may poll the source repository for content objects having the appropriate file types.

In some cases, basic metadata may be returned in response to polling the source repository. For example, scanning a file share will result in the basic metadata for files stores in a target directory. System metadata processing module 110 may gather additional metadata for the content objects identified. The metadata gathered may be a default set of metadata or metadata specified in configuration information 115. According to one embodiment, system metadata processing module 110 may gather basic file metadata from the source repository if not gathered already and gather extended metadata by examining extended metadata of the content objects to extract all or some of the extended metadata. The extracted metadata, in some cases, comprises extended file properties associated with a particular MIME type. System metadata processing module stores the gathered metadata for some or all of the identified content objects in content assessment repository 120.

Content analytics module 112 opens the identified content objects and examines the content to identify whether the content objects contain the content of interest. For example, content analytics module 112 may scan the contents of a content object to determine if the content object contains a string matching a specified pattern for a credit card. If content analytics module 112 finds the content of interest (e.g., the string matching the pattern), content analytics module may flag the content object in content assessment repository 120 or store the target content of interest in content assessment repository 120.

In some cases, contents analytics module 112 may not be able to open a content object. This may occur if the content object is password protected or otherwise secured and content assessment system 102 lacks the credentials to open the content object. In this case, system metadata processing module 110 may gather what metadata is available for the content object, which may also be limited by the password protection, and populate content assessment repository with the metadata. Content analytics module 112, however, does not add data for the content object in content assessment repository 120. Content analytics module 112 may flag an entry content assessment repository in a manner that indicates that the object could not be properly processed or may not make an entry at all.

The structured content assessment data may be examined to identify content objects to decommission, delete, move, copy, or otherwise further process. For example, transfer module 114 may quickly identify content objects to copy or move from the source repositories to target repository system 146 (or local repository 116) using the structured content assessment data. The ability to quickly identify objects of interest for subsequent processing can be facilitated by the structured nature of the structured content assessment data.

As discussed above, according to one embodiment structured content data only includes entries for content objects in which targeted content of interest was located (and possibly for content objects that could not be opened). Using the example of identifying content objects containing credit card numbers, structured content assessment data 122 may include entries for only those content objects that were identified as containing credit card numbers. Thus, the fact that an entry for a content object exists in structured content assessment data 122 indicates that the content object is of interest. Accordingly, a transfer module 114 configured to transfer content objects containing credit card numbers may move all objects identified in content assessment data 122 to the target repository.

In another embodiment, structured content assessment data may contain entries for content objects that did not contain the structured content of interest. Using the example of identifying content objects containing passport numbers, structured content assessment data 124 may include entries for content objects that contained passport numbers and those that did not. In some cases, the repository may be structured so that a data structure, such as table, holds entries for only those content objects that contained the information of interest. Identifying content objects that contain passport numbers in such as case would be a simple matter of querying the table that contains information for only those content objects containing the passport number.

In another embodiment, information for content objects containing the target content of interest and those not containing the target content of interest may be stored in the same data structure with the target content of interest (or indication of the target content of interest) stored in a structured data element. In this case, identifying content of objects interest may still be a relatively simple process of querying the repository for records having a non-null value for the target content interest (e.g., for records in which a passport number or indication of a passport number is not null).

As part of copying or moving content objects, transfer module 114 may map content assessment data for the content objects to metadata for the content object in the target repository. In particular, transfer module 114 may map metadata and content of interest from structured data elements in content assessment repository 120 to metadata at target repository system 146. For example, if target repository system 146 is an ECM system, transfer module 114 can map a credit card number from structured content assessment data 122 to an extended file attribute or other metadata for the content object in target data store 148.

Content assessment system 102 may take other actions with respect to content objects of interest. Content assessment system 102, according to one embodiment, may identify content objects containing target content of interest and communicate with the source repository so that the content object is classified at the source repository. For example, content assessment system 102 may identify content objects containing credit card numbers and communicate with ECM system 128 so that those content objects are identified as containing sensitive data in ECM system 128. As another example, content assessment system may put a records management hold on content objects of interest at the source repository or target repository.

According to one embodiment, content assessment system 102 can use content assessment repository 120 to check for changed/added/deleted content objects. If a content object having an entry in content assessment repository 120 has been deleted from the source repository, an entry will remain in content assessment repository 120. Consequently, the next time content assessment system 102 profiles content objects at the source repository, content assessment system can determine if all the content objects listed in content assessment repository 120 from that source repository are still present. If a content object has been deleted from the source repository, a flag which indicates the content object no longer exists can be added to the entry for that content object in content assessment repository 120. If an object has been changed, a new entry can be created. The old entry for the same document can be updated indicating it is no longer current or may be deleted.

Content assessment system 102 may also create a hash for each content object processed. The hash can be used to identify duplicate content objects. Consequently, duplicate content objects may be deleted. Maintaining an entry in the content assessment repository for the deleted content object showing the identical hash to a still existing content object can be used to show that no information was lost through the deletion of the duplicate content object.

According to one embodiment, content assessment system 102 may create a set of structured content assessment data without creating or using a full-text search index. Thus, content assessment system 102 does not create a full-text index of ECM content objects 132, database content objects 138 or file share content objects 144. This may be particularly beneficial when there is a large number of documents in which a relatively small amount of information is of interest for specific reasons, particularly when there is more than, for example, 250 GB of documents to be assessed because documents containing information of interest can be identified without waiting for an index of the source repositories to be created. While particularly beneficial with larger amounts of data, embodiments of the present disclosure can be used with smaller amounts of data, including less than 1 GB of data.

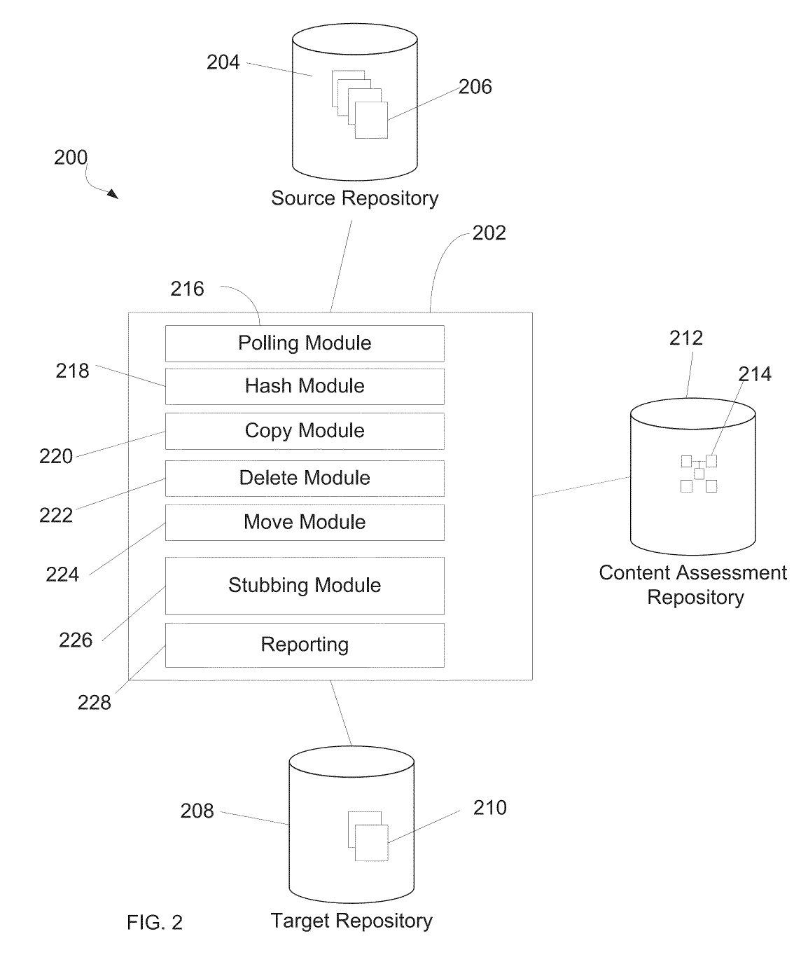

Turning now to FIG. 2, an embodiment of a content profiling and transfer architecture 200 is depicted. Content profiling and transfer architecture 200 comprises a content assessment system 202, which may be implemented as a computing device having a CPU, memory, I/O devices, network interfaces and the like executing computer executable instructions stored on a non-transitory computer readable medium.

According to one embodiment, content assessment system 202 can be coupled to a source repository 204 storing content objects 206, a target repository 208 storing migrated content objects 210 and a content assessment repository 212 storing structured content assessment data 214.

Content assessment system 202 can provide a polling module 216. Polling module 216 can support mapped drives and universal naming conventions (UNCs) and can be configured to poll a file share or other source repositories for content objects having certain MIME types. Thus, for example, polling module may poll source repository for word processing documents, spreadsheet files, presentation files, image files, audio files or other files. Polling module 216 may apply metadata processing and content analytics to the content objects identified in response to polling to gather metadata and parse the contents of the content objects for particular pieces of information and thus may comprise a system metadata processing module and a content analytics module as discussed above.

Polling module 216 may further store data extracted from the content of the objects in the content assessment repository 212. The information extracted, both structured and unstructured, may be stored according to a set of table schemas. Tables for storing basic file properties such as “name,” “modified date,” and mime type can be created and tables for storing extended file properties and target content of interest can be created. The schemas can also store a variety of other information, including runtime information such as when the polling for each object happened. The schemas can further store execution information such as actions taken against an object. For example: object added to content server; object deleted from file share; object had records management (RM) hold placed, etc.

Content assessment system 202 can further comprise hash module 218. Hash module 218 can be configured to run a hashing algorithm over the contents of a content object to generate a hash that can be stored in content assessment repository 212 for the content object. This hash can be used to identify content objects which might be duplicates.

Thus, content assessment repository 212 may be used to determine, for example, how many of the objects are duplicates or the last time a person accessed a type of document. In addition, the content assessment repository may be used to track kinds of remediation. For example, it may be used to track whether a document or other content object was archived or deleted (and when or by whom) and generally maintain the provenance of an object.

Copy module 220 can be configured to copy documents from a source repository to a target repository according to a set of rules. The rules may include rules regarding mapping of entries in content assessment repository 212 to metadata attributes of target repository 208. Copy module 220 may implement a mass file copy to copy objects from source repository 204 to target repository 208. In particular, copy module 220 may identify objects in the source repository 204 from content assessment repository 212, the identified content objects having particular characteristics (e.g., age, containing certain data, etc.) and copy the objects from source repository 204 to target repository 208.

Delete module 222 can be configured to delete objects from source repository 204 according to a set of rules. By way of example, a delete module 222 can be configured to delete content objects older than 4 years from file shares. The delete module 222 can identify the objects to be deleted from content assessment repository 212.

Move module 224 is configured to move content objects from source repository 204 to target repository 208 according to a set of rules, such as rules regarding mapping of metadata from source repository 204 or content assessment repository 212 to target repository 208. Move module 224 may implement a mass move operation to move objects from source repository 204 to target repository 208. In particular, move module 224 may identify objects from content assessment repository 212 having particular characteristics (e.g., age, containing certain data, etc.) and move the objects from source repository 204 to target repository 208.

Stubbing Module 226 can be configured to assign categories, attributes and records management metadata on content objects in a target repository 208. Stubbing module 226 may further associate/link, in content assessment repository 212, the content object in target repository 208 to the original source object in source repository 204. For example, when a content object from source repository 204 containing credit card information is copied to target repository 208, stubbing module 226 may create a “sensitive data” category and associate the content object with the sensitive data category. Furthermore, stubbing module 226 can create an association in content assessment repository 212 between the copy of the content object in target repository 208 and the original content object in source repository 204.

Reporting module 228 can be configured to generate reports over information in content assessment repository 212 to provide intelligence into content objects in source repository 204 or target repository 208.

When the modules take various actions, content assessment repository can be updated to indicate what action has taken place against an object, when the action took place, and who performed the operation.

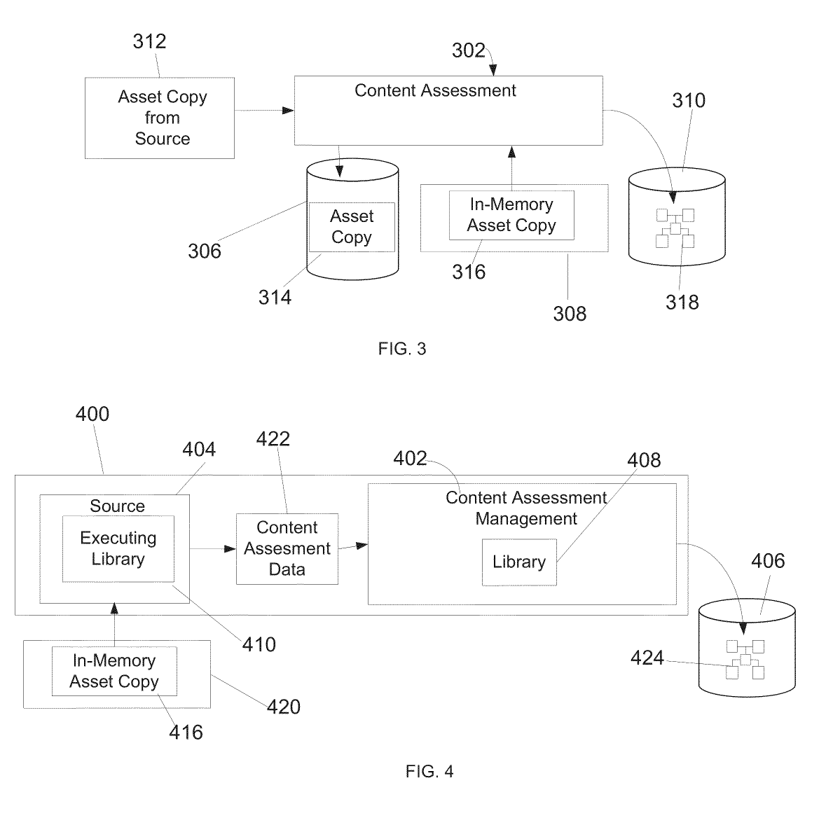

Processing of content objects may take place in a variety of manners by a content assessment system. FIG. 3 is a functional block diagram of one embodiment of an architecture for processing content objects. In this architecture, a content assessment system 302 may include persistent storage 306, such as a hard drive, and volatile memory 308, such as RAM or processor memory, and a content assessment repository, which may share resources or be separate from storage 306. Content assessment system 302 receives a copy of content object 312 from a source repository system, stores the copy in persistent storage (content object copy 314), opens the content object in memory (in-memory content object copy 316), processes the content object to extract metadata and target content of interest and populates structured content assessment data 318 in content assessment repository 310.

Content assessment system 302 may apply multithreading or other techniques to perform multiple processes on multiple content objects in parallel. Even so, sending copies of content objects over the network requires large amounts of network bandwidth for content assessment projects that involve profiling a large number of content objects. Consequently, the scalability of the architecture of FIG. 3 may be limited by network resources.

Accordingly, it may be desirable to use less network bandwidth in performing content assessment. To this end, FIG. 4 depicts an architecture having a distributed content assessment system 400 that may use less network bandwidth per content object processed. Distributed content assessment system 400 may include a content assessment management system 402 and a source system 404. Content assessment management system 402 may provide overall control of a content assessment process while source system 404 performs metadata gathering and identification of content objects containing target content of interest.

As would be understood by one of ordinary skill in the art, ECM servers, network file servers, database servers and other computers that manage content repositories often provide a mechanism for a client computer or other computer to execute libraries in the memory of the server as part of accessing content through the server. Therefore, content assessment management system 402 may provide a library 408 for execution at source system 404 as executing library 410. Executing library 410 causes source system 404 to gather metadata and identify content of interest in content objects.

In operation, content assessment management system 402 connects to source system 404 and determines the identities of content objects to process according to configuration information, as discussed above. Rather than requesting a copy of the content object, however, content assessment management system 402 provides source system 404 with library 408, which source system 404 executes in memory as executing library 410.

Source system 404 may open a content object in volatile memory 420 (shown as in-memory content object copy 416), process the content object to gather metadata, identify target content of interest in the content object and return a set of content assessment data 422 to content assessment management system 402. Content assessment data 422 includes the gathered metadata and target content of interest for the content object or an indication of whether the content object contained the target content of interest. Content assessment management system 402 can store the content assessment data as structured content assessment data 424 in content assessment repository 406.

Content assessment data 422 may be fairly small in size and will typically be much smaller than the corresponding content object. Consequently, sending content assessment data 422 for a large number of content objects over a network will require much less bandwidth than sending the content objects over the network.

In this embodiment, the functionality of various modules discussed above, such as the system metadata processing module and content analytics module may be distributed between the content assessment management system 402 and the source system 404. While this is done through the example of a library in FIG. 4, the functionality of a content assessment system can be otherwise distributed including, for example, through the use of agents or other programs at the source systems or other computers.

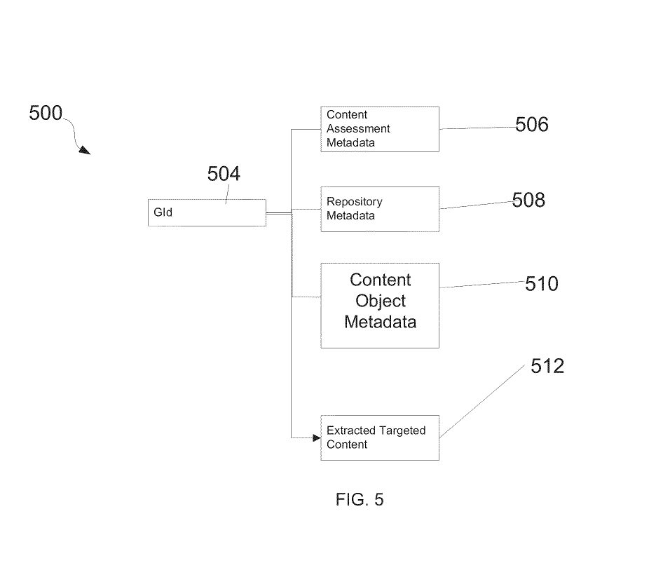

FIG. 5 depicts one embodiment of structured content assessment data 500. Structured content assessment data for a content object may include a content object global id 504, content assessment metadata 506, repository metadata 508, content object metadata 510 and extracted targeted content 512. The various pieces of information may all be linked to the global id for the content object.

According to one embodiment, each content object that is processed can be assigned a content object global id 504 that uniquely identifies that content object in a content assessment repository. If a content object is copied or moved from a source repository to a target repository, the copy of the content object may be assigned a new id.

Content assessment metadata 506 can include metadata assigned by a content assessment system to a content object. For example, a hash value or other information may be associated with content assessment metadata 506. Repository metadata 508 can comprise metadata maintained by the repository in which the content object is stored. Repository metadata 508 may include metadata that goes beyond the basic and extended file properties, such as document categories, records management flags. Content object metadata 510 can include metadata of the specific content object. For files, the content object metadata 510 may include basic file properties, extended file properties and other file metadata. Extracted targeted content 512 may include targeted content extracted from the content object or an indication that the content object included the targeted content.

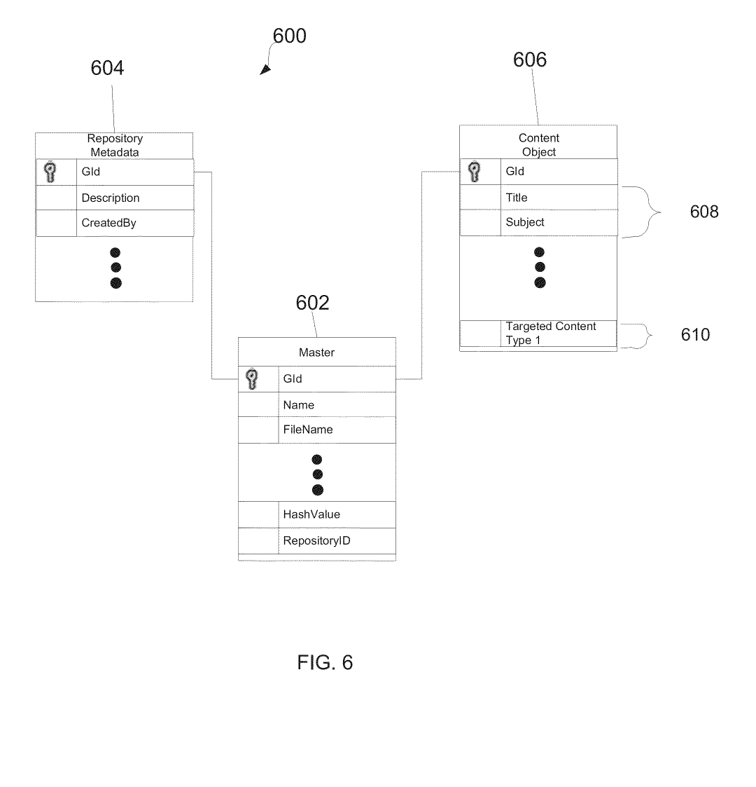

Structured content assessment data may be stored in a variety of structured schemas. FIGS. 6-9 depict various embodiments of example schemas. FIG. 6 depicts one embodiment of a structured content assessment data schema 600 comprising a master table 602, a repository metadata table 604 and a content object metadata table 606. A global id can be used as a primary key or foreign key, and in some cases both, for various tables, making locating all the records for a content object a relatively simple task. According to one embodiment, master table 602 is a parent table and repository metadata table 604 and content object metadata table 606 are child tables related through the global id.

Master table 602 includes a column for the content object global id, columns for basic file properties that are common to file types supported by the content assessment system, such as name and full filename, columns for content assessment metadata, such as the file hash, and a column to identity of the repository in which the content asset is stored.

Repository metadata table 604 includes a column for the content asset global id and columns for metadata maintained by a repository for a content object. The repository metadata may include metadata maintained by the repository system. For example, an ECM repository may include document categories, description metadata and other metadata for files that are not part of the file properties.

Content object metadata table 606 includes a column for the content asset global id and columns for content object metadata 608. The content object metadata, according to one embodiment, can comprise basic and extended file properties of the content object. Content object metadata table 606 may further include an extracted target content of interest column 610. In this case, if the content of interest is a credit card number, content object metadata table 606 can include a column for credit card number with the field values for each content object being a credit card number extracted from the content object or a flag indicating that the content object contains a credit card number. In some cases, content object metadata table 606 may include columns for multiple types of content of interest (e.g., a column for credit card number, a column for social security number, a column for passport number).

Metadata attributes such as “owner” found in document metadata, may be mapped automatically to the relevant column in the relevant table of the schema. Information from text analytics or other analytics may also be stored in corresponding entries in the schema. In content object metadata table 606, for example, the content object metadata and targeted content of interest are stored in related fields. In this case, the metadata fields and targeted content of interest field are in the same record that has the global id as the primary key. Thus, it is simple to identify content objects that contain targeted content of interest and run reports or perform actions that use both the content object metadata and content of interest.

Using the global id as a primary key for a table that includes targeted content of interest may have shortcomings if multiple pieces of the same type of content of interest are extracted from a content object. Using the example of object metadata table 606 and using the global id as the primary key, a content object may only have one entry. A content object having multiple pieces of content of interest, say two different credit card numbers, will have only one credit card number entered in the target content field or may have both entries in the same field depending on the configuration of the content assessment system. However, this may be undesirable as many database management programs will treat a field as having a single field value, requiring that applications utilizing the results of a database query have the intelligence to separate the values from within a single field (e.g., to identify the two credit card numbers from within the targeted content of interest field value for the content object). One way to alleviate this concern is to have the global id be a foreign key, but not a primary key, so that multiple entries may exist in table 606 for the same global id. In this case, there could be one row for the content object containing the first credit card number and a second row for the content object containing the second credit number. However, this may lead to excessive duplication of much of content object metadata 608 for a content object when a content object has many different pieces of target content.

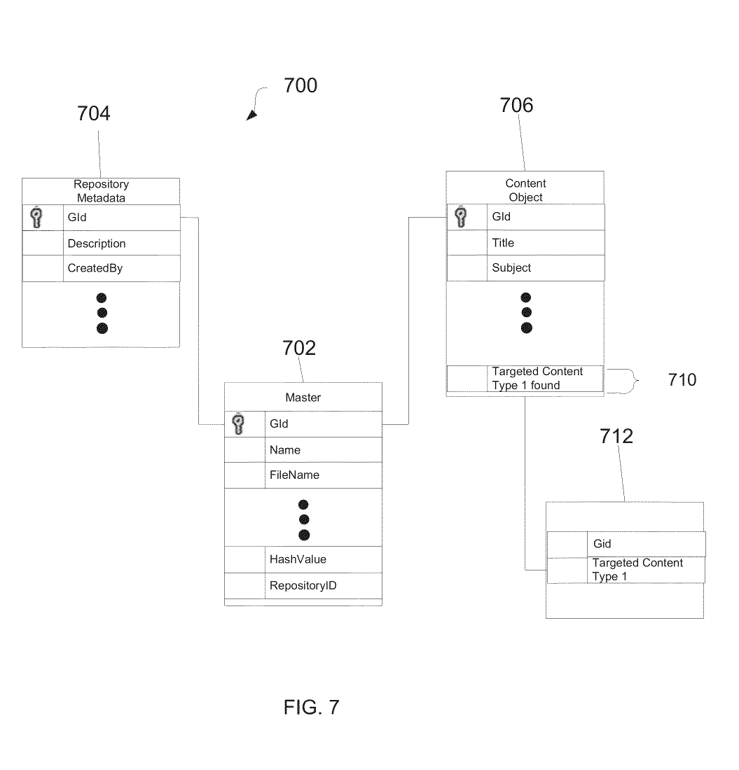

Turning to FIG. 7, a structured content assessment data schema 700 is depicted that can reduce duplication of content object metadata. Structured content assessment data schema comprises a master table 702, a repository metadata table 704 and a content object metadata table 706 similar to those discussed above. In FIG. 7, however, content object metadata table does not store targeted content of interest, but instead indicates that the targeted content of interest has been found (column 710) and relates to a child content of interest table 712. Content of interest table 712 can contain columns for the global id and the targeted content of interest. Content of interest table 712 may use the global id as foreign key so that multiple target content of interest fields may exist for a content object. In this example, the content of interest can be stored in fields that are formally related to the content object metadata fields for the content object through the relationship between content object metadata table 706 and content of interest table 712.

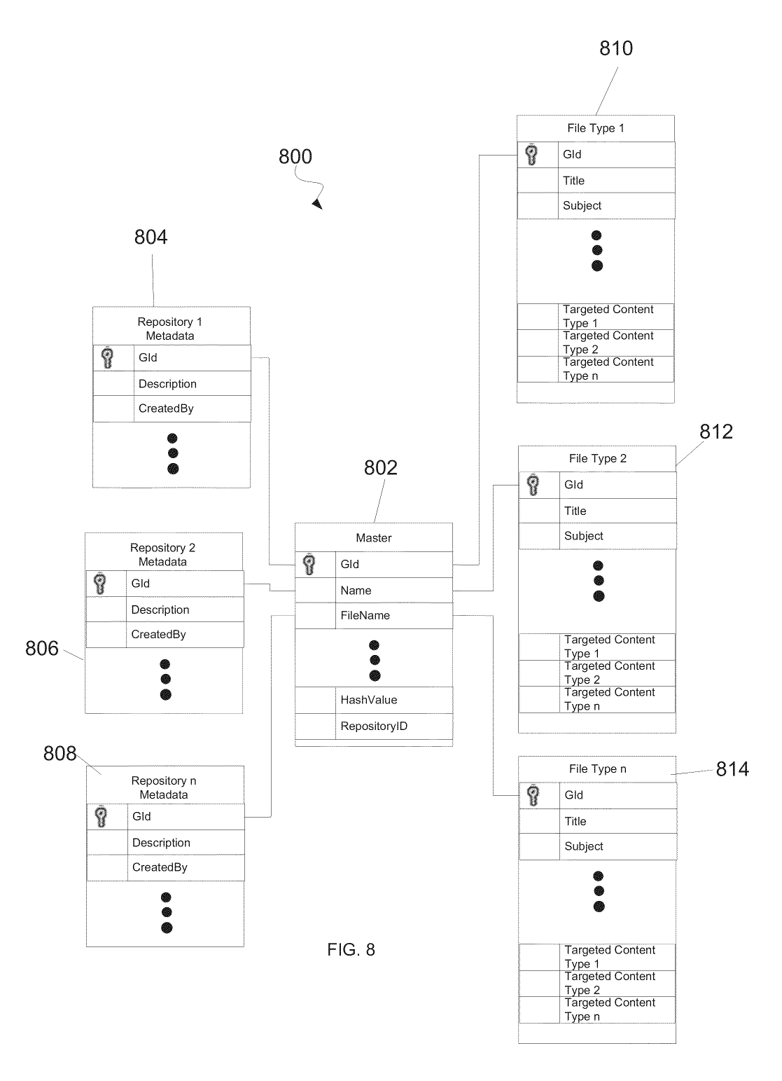

FIG. 8 depicts another embodiment of a structured content assessment data schema 800. Structured content assessment data schema 800 comprises a master table 802, a first repository metadata table 804, a second repository metadata table 806, a third repository metadata table 808, a first content object metadata table 810, a second content object metadata table 812 and a third content object metadata table 814.

Each repository metadata table may correspond to a specific source or target repository identified in master table 802. Each content object metadata table may correspond to a different content object type. For example, first content object metadata table 810 may store content object metadata and target content of interest for files having a first MIME type (e.g., word processing documents), second content object metadata table 812 may store content object metadata and target content of interest for a second MIME type (e.g., spreadsheet documents) and third content object metadata table 814 may store content object metadata and target content of interest for a third MIME type (e.g., presentation documents).

FIG. 8 also depicts that the content object metadata tables may store content of interest or content of interest flags for multiple types of content of interest (e.g., credit card, social security number, passport number) in fields related to the content object metadata as part of the same record or through a relationship between tables as discussed above.

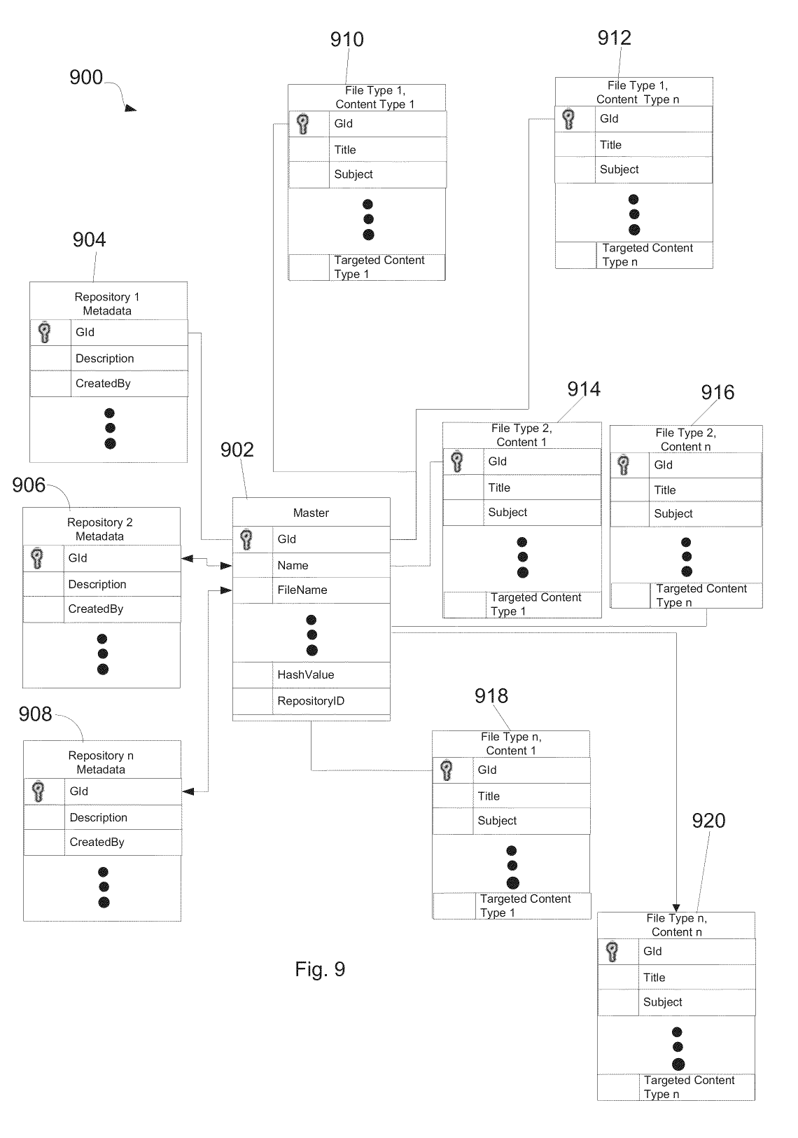

FIG. 9 depicts another embodiment of a structured content assessment data schema 900. Structured content assessment data schema 900 comprises a master table 902, a first repository metadata table 904, a second repository metadata table 906, a third repository metadata table 908, a first content object metadata table 910, a second content object metadata table 912, a third content object metadata table 914, a fourth content object metadata table 916, a fifth content object metadata table 918 and a sixth content object metadata table 920.

Each repository metadata table may correspond to a specific source or target repository identified in master table 902. Each content object metadata table may correspond to a different content object type and target content of interest type. For example, first content object metadata table 910 and second content object metadata table 912 may store content object metadata and target content of interest for files having a first MIME type (e.g., word processing documents), third content object metadata table 914 and fourth content object metadata table 916 may store content object metadata and target content of interest for a second MIME type (e.g., spreadsheet documents) and fifth content object metadata table 918 and sixth content object metadata table 920 may store content object metadata and target content of interest for a third MIME type (e.g., presentation documents).

Different tables for the same content object type may correspond to different types of content of interest. For example, in a system that identifies documents having credit card numbers and documents having social security numbers, first content object metadata table 910 may store content object metadata and credit card numbers for word processing documents that contain credit card numbers and second content object metadata table 912 may store content object metadata and social security numbers for documents that contain social security numbers. In this case, a word processing document that contains a credit card number and a social security number may have an entry in both tables. As discussed above, in another embodiment, the content of interest fields may include flags that the content of interest was found in the content object, while the content of interest is not stored by the content assessment system or is stored elsewhere such as in a related table.

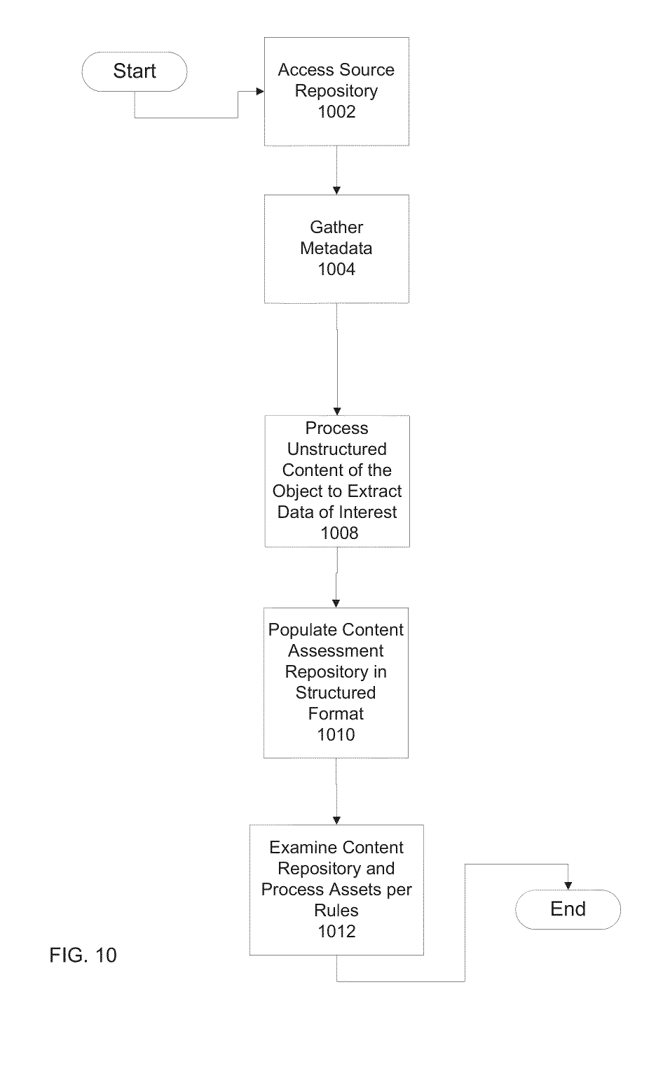

Turning not to FIG. 10, FIG. 10 is a flow chart of one embodiment of a method for content assessment. At step 1002, a source repository is accessed. This may include the content assessment system connecting to a server or other computer that manages access to content objects in a data store.

At step 1004, metadata for a content object may be gathered. Gathering the metadata may include receiving content object metadata and repository metadata from the source repository. In one embodiment, a portion of the metadata may be gathered by polling the source repository for content objects and receiving a listing of basic metadata in response. A content assessment system may also extract additional metadata from the source repository such as extended properties, repository metadata and other metadata. One or more metadata extraction rules may be used to extract the corresponding metadata.

At step 1008, a content object is processed to extract target data of interest. Based on one or more criteria, such as object type or object source or organizational entity, one or more corresponding analytics processing rules may be accessed to apply to the content object. Unstructured content of the object may be processed to extract content data from the unstructured contents of the object according to the rules. According to one embodiment, this can be done without having to create, store and maintain a separate search index for the content objects.

According to one embodiment, the content object may be opened and processed at the source repository system such that the source repository system provides the content of interest extracted from the content object or an indication that content object includes the target content of interest. In another embodiment, a content assessment system opens a copy of the content object remote from the source repository and processes the unstructured content to extract the target content of interest or generate an indication that content object includes the target content of interest.

At step 1010, the metadata and target content of interest (or an indication that the content object contains the target content of interest) is stored as structured data in a content assessment repository. According to one embodiment, a content assessment system may interact with a relational database to store content object metadata in a set of metadata fields and store the targeted content of interest as structured data in a field of the relational database. The metadata fields and targeted content field for a content object may be related in the database.

The content assessment database may be examined for objects relevant to one or more criteria, and the corresponding objects may be processed accordingly at step 1012. Identifying content objects of interest may include, for example, determining one or more items of content assessment data that include information of interest and identifying the content objects associated with that content assessment data. Various actions may be taken on the identified content objects including transferring the content objects, reporting on the content objects or other action. The database may then be updated to reflect the nature of the remediation or other action enacted upon the content objects.

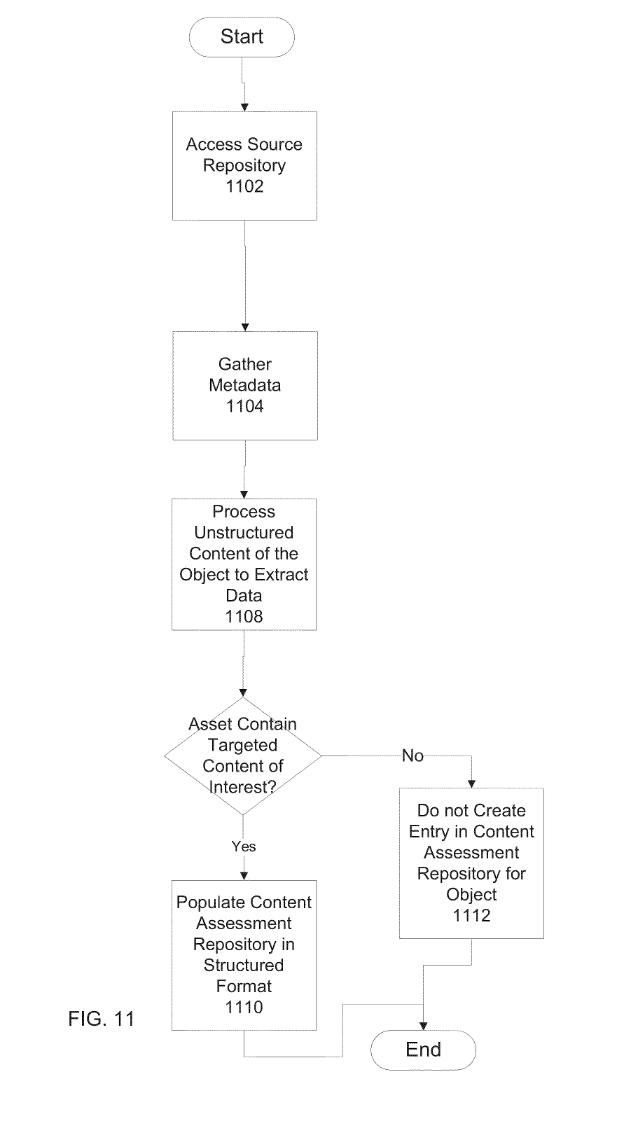

FIG. 11 is a flow chart of one embodiment of a content assessment method. A source repository may be accessed at step 1102. Metadata for a content object may be gathered at step 1104 and the content object processed to extract target data of interest at step 1108. If the asset contains the target data of interest, the content assessment repository can be populated with the metadata and target data of interest in step 1110. However, according to one embodiment, if the content asset does not contain the target data of interest, an entry is not created for the content object in the content assessment database (step 1112). Consequently, content objects having target content of interest are easily identifiable as those having entries in the structured content assessment data.

In another embodiment, some information may be populated in the content assessment repository for the selected content object lacking the target content of interest, but not other information. Using the example schemas above, the master table and repository metadata table may be populated with an entry for the object, but the content object metadata table not populated. Consequently, all the content objects may be tracked in the content assessment database, while the objects containing target content of interest remain easily identifiable as those content objects having entries in the content object metadata table. In another embodiment, the content assessment repository may be populated for the content object, but the entry for the target content of interest left null.

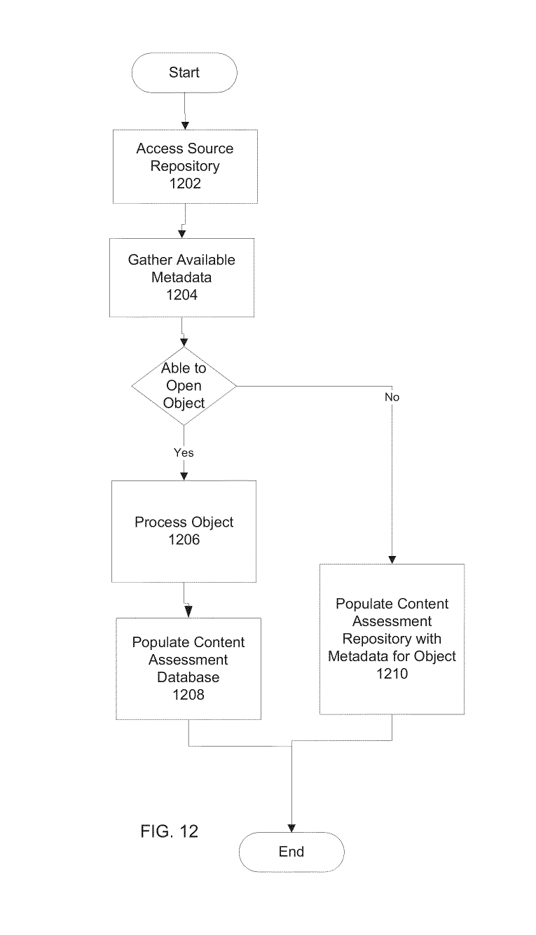

FIG. 12 is a flow chart depicting one method of processing content objects when some content objects may not be opened to allow content analytics. This may occur, for example, if a content object is password protected and the content assessment system lacks the credentials to open the content object.

The source repository containing a content object may be accessed at step 1202. At step 1204, available metadata for a content object can be gathered. The available metadata may vary by source repository, but, as an example, some repository metadata (e.g., containing folder and file path), basic file properties and some extended file properties are often available from file shares without opening a file.

At step 1204 a determination can be made as to whether a selected content object can be opened. In response to a determination that the content object can be opened, the content object can be processed to extract additional content object metadata or target content of interest (step 1206) and the content assessment repository populated (step 1208). In some cases, a content assessment repository may be populated for an entire set of content objects that can be opened. In another embodiment, the content assessment system is configured to create records in a content assessment repository only for those opened content objects that contain targeted content of interest.

If, however, the content object cannot be opened, the content assessment repository may be populated only with the available metadata for the content object that cannot be opened (step 1210). In one embodiment, the set of available metadata for the content object can be stored in the content assessment repository. In other cases, the content assessment system does not store metadata for content objects that could not be opened.

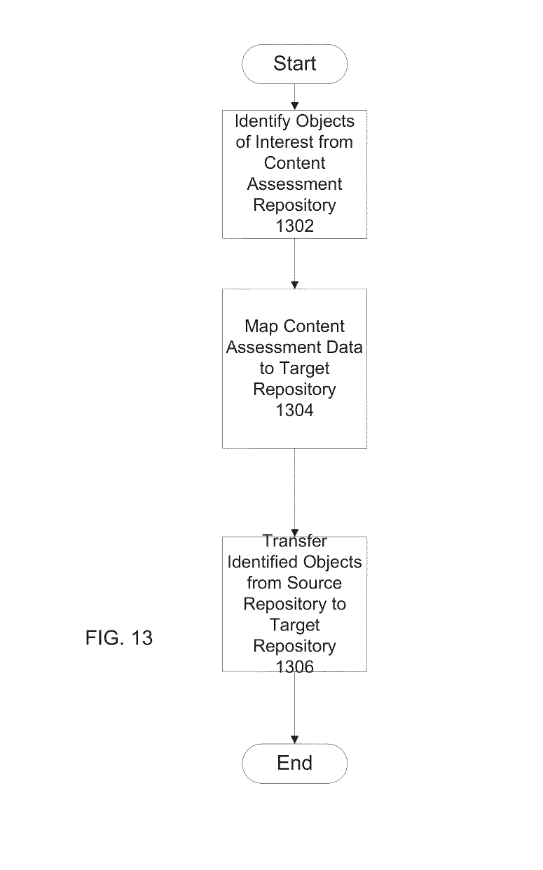

FIG. 13 is a flow chart depicting one embodiment of a method for transferring content objects from a source repository to a target repository. Content objects in a source repository can be identified for transfer (step 1302). The content objects can be identified using the structured content assessment data in the content assessment repository. According to one embodiment, the content assessment system can identify all content objects having a record in a set of structured content assessment data as for transfer. In another embodiment, the content assessment system can identify content object records that have an entry in a targeted content field to identify the content objects for transfer. In yet another embodiment, the content assessment system may identify records having specific metadata or target content of interest values as content objects to transfer.

For the identified content objects, content assessment data can be mapped to the metadata structure of a target repository (step 1304). This may include mapping content assessment data into the regular and/or extended attributes of the target repository. Using the example of the structured content assessment data schemas discussed above, one or more fields of the master table, repository metadata table and content object table may be mapped to metadata of the target repository. In some cases, target content of interest that was unstructured in the source repository may be stored as structured metadata in the target repository.

The identified content objects can be copied from the source repository to the target repository at step 1306. According to one embodiment, the transfer operation can be performed as a mass copy or mass move operation of the content objects identified. Thus, the content assessment data may be used to facilitate mass file transfer operations.

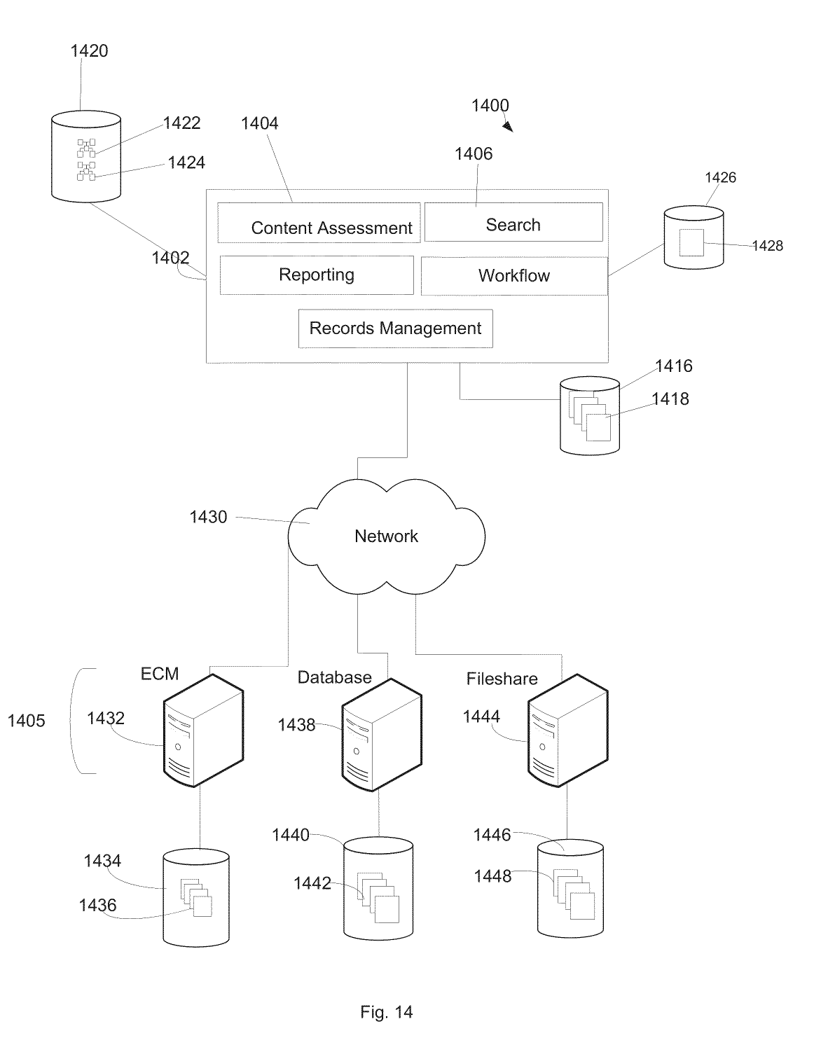

A content assessment system may be implemented as part of an integration system that executes processes, workflows, decommissioning, migration, copying, and in-place records management and provides other services. To this end, FIG. 14 depicts one embodiment of a content integration architecture 1400. Content integration architecture 1400 includes an integration system 1402 and source repository systems 1405 communicating via a network 1430, which may be, for example, the Internet, an intranet, a LAN a WAN, an IP based network, etc. These communications may be accomplished according to one or more protocols such as, for example, HTTP or SOAP and in one or more formats.

Source repository systems 1405 may include any number of different types of source repository systems, including, but not limited to an ECM system 1432 managing an ECM data store 1434 storing ECM content objects 1436, a database system 1438 managing a database data store 1440 storing database content objects 1442 and a network file server 1444 having a file share data store 1446 storing file share content objects 1448. The content objects stored in the source repository data stores may include files, records and other data structures.

Integration system may comprise one or more computing devices executing a content assessment application 1404, a search engine application 1406 and other applications, such as workflow, records management and reporting. Integration system 1402 can further include a local repository 1416 that can store local content objects 1418. Local repository 1416 may be a source repository, a target repository or an intermediate repository storing content objects during content profiling. Integration system 1402 may also include and a content assessment repository 1420 storing structured content assessment data, with structured content assessment data 1422 and structured content assessment data 1424 depicted. Content assessment repository may be a network accessible repository, such as a network accessible database managed by a database server, or may be a local repository. Local repository 1416 and content assessment repository 1420 may share the same storage media or may use different storage media.

Integration system 1402 may further include a search index repository 1426 that stores a full text search index 1428 to allow a search engine to process searches of content objects in source repository systems 1405. However, it can be noted that, in the embodiment depicted, full text search index 1428 is maintained separately from the structured content assessment data, though content assessment and search may share storage resources. Thus, content assessment may be integrated or used in conjunction with processes that use full text search indexes for other purposes. Furthermore, a relational database system may maintain a database index for the content assessment data to increase the speed of responding to database queries.

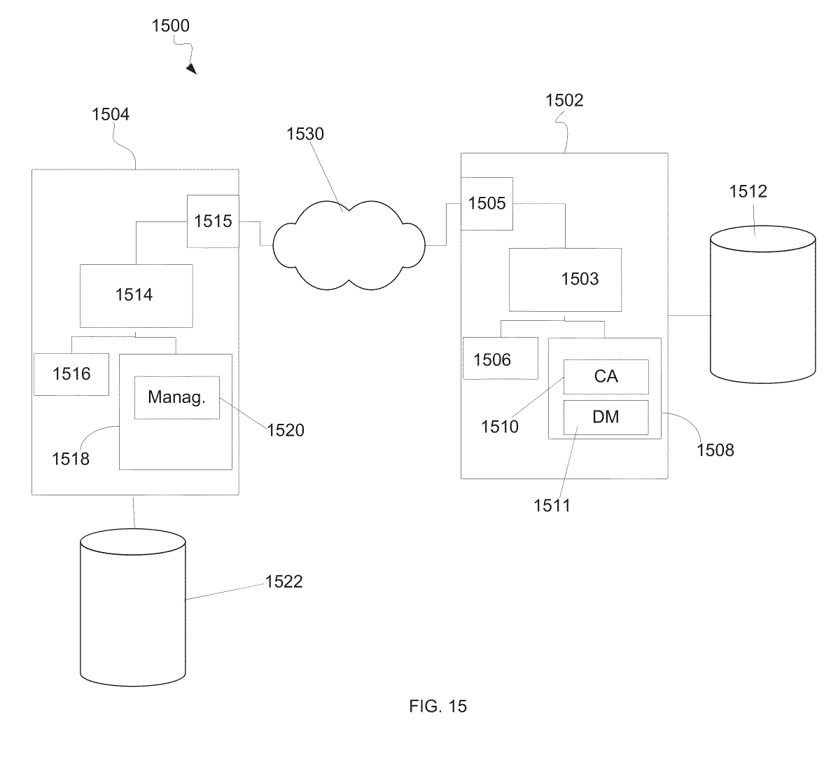

FIG. 15 is a diagrammatic representation of one embodiment of a content assessment and transfer architecture 1500 comprising a content assessment system 1502 coupled to a content repository system 1504, such as source repository system or a target repository system, via a network or other communications link 1530. Each of content assessment system 1502 and content repository system 1504 may include a processor (CPU 1503 and CPU 1514), communications interfaces (interface 1505 and interface 1515), memory (memory 1506 and memory 1516), persistent storage (storage 1508 and storage 1518), I/O devices and other hardware. Content assessment system 1502 may maintain a content assessment repository 1512 and content repository system 1504 may maintain a data store 1522 of content assets.

According to one embodiment, content assessment system may include a variety of applications including a content assessment application 1510 and a relational database management application 1511. Content assessment application 1510 can interact with relational database management application 1511 to store metadata and extracted target content of interest as structured data in content assessment repository 1512.

Content repository system 1504 may include management and server applications 1520 to manage content objects in data store 1522 and allow clients to retrieve metadata, access content objects and perform other functions with respect content objects in data store 1522. Content assessment system 1502 can thus interact with the content repository system to gather metadata, access content objects, store content objects or perform other operations. According to one embodiment, content assessment application 1510 may be executable to provide a library to server management application 1520 for execution in the memory of content repository system 1504 such that content assessment is distributed between content assessment system 1502 and content repository system 1504.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function.

While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more computing devices by using application specific integrated circuits, programmable logic devices, field programmable gate arrays, optical, chemical, biological, quantum or nanoengineered systems, components and mechanisms may be used. Distributed or networked systems, components and circuits can be used. In another example, communication or transfer (or otherwise moving from one place to another) of data may be wired, wireless, or by any other means.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term. Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for profiling content in a data repository, comprising:
a source repository;
a content assessment system configured to connect to the source repository, the content assessment system comprising:
a relational content assessment database;
a metadata processing module configured to gather metadata of content objects stored in the source repository and store the metadata of the content objects as structured data in a set of metadata fields of the relational content assessment database; and
a content analytics module configured to process unstructured content of the content objects to automatically extract targeted content of interest from the unstructured content and store the targeted content of interest as structured data in a targeted content field of the relational content assessment database, the targeted content field corresponding to a particular content object related to the set of metadata fields for that content object in the relational content assessment database.

2. The system for profiling content of claim 1, wherein:
the gathered metadata comprises file properties for the content object; and
the set of metadata fields and the targeted content field corresponding to the particular content object are related to a primary key comprising an identification for that particular content object.

3. The system for profiling content of claim 1, wherein the content analytics module is configured to parse the content of the content objects and pattern match the content of the content objects to extract the targeted content of interest.

4. The system for profiling of claim 1, wherein the content assessment system further comprises a transfer module configured to:
identify a subset of content objects for transfer to a target repository based on the relational content assessment database;
map the gathered metadata for the subset of content objects from the relational content assessment database to target repository metadata for the subset of content objects; and
interact with a source repository system and a target repository system over a network to transfer the subset of content objects to the target repository.

5. The system for profiling content of claim 4, wherein identifying the subset of content objects for transfer based on the relational content assessment database comprises identifying content object records in the relational content assessment database having an entry in the targeted content field.

6. A method for profiling content comprising:
connecting a content assessment system to a source repository;
at the content assessment system:
gathering metadata of content objects stored in the source repository;
processing unstructured content of the content objects to automatically extract targeted content of interest from the unstructured content and; and
interacting with a relational database to store the metadata of the content objects as structured data in a set of metadata fields of a relational content assessment database and store the targeted content of interest as structured data in a targeted content field of the relational content assessment database, the targeted content field corresponding to a particular content object related to the set of metadata fields for that content object in the relational content assessment database.

7. The method of claim 6, wherein:
the gathered metadata comprises file properties for the content object; and
the set of metadata fields and the targeted content field corresponding to the particular content object are related to a primary key comprising an identification for that particular content object.

8. The method of claim 7, further comprising parsing the content of the content objects and pattern matching the content of the content objects to extract the targeted content of interest.

9. The method of claim 6, further comprising:
identifying a subset of content objects for transfer to a target repository based on the relational content assessment database;
mapping the gathered metadata for the subset of content objects from the relational content assessment database to target repository metadata for the subset of content objects; and
transferring the subset of content objects to the target repository.

10. The method of claim 9, wherein identifying the subset of content objects for transfer based on the relational content assessment database comprises identifying records having an entry in the targeted content field.

11. A system for transferring content, comprising:
a source repository;
a target repository;
a content assessment system configured to connect to the source repository and the target repository, the content assessment system comprising:
a relational content assessment database;
a metadata processing module configured to gather metadata of content objects stored in the source repository and store the metadata of the content objects as structured data in a set of metadata fields of the relational content assessment database;
a content analytics module configured to process unstructured content of the content objects to automatically extract targeted content of interest from the unstructured content and store the targeted content of interest as structured data in a targeted content field of the relational content assessment database; and
a transfer module configured to:
identify a subset of content objects for transfer from the relational content assessment database;
map the gathered metadata for the subset of content objects from the relational content assessment database to target repository metadata; and
transfer the subset of content objects from the source repository to the target repository based on the relational content assessment database.

12. The system for transferring content of claim 11, wherein the transfer module is further configured to map targeted content of interest for the subset of content objects from the relational content assessment database to target repository metadata.

13. The system for transferring content of claim 11, wherein:
the gathered metadata comprises file properties for the content object; and
the set of metadata fields and the targeted content field corresponding to a particular content object are related to a primary key comprising an identification for that particular content object.

14. The system for transferring content of claim 11, wherein the content analytics module is configured to parse the content of the content objects and pattern match the content of the content objects to extract the targeted content of interest.

15. The system for transferring content of claim 11, wherein the transfer module copies the subset of content objects from the source repository to the target repository in a mass file transfer operation.

16. The system for transferring content of claim 11, wherein the transfer module moves the subset of content objects from the source repository to the target repository.

17. A method, comprising:
connecting a content assessment system to a source repository;
at the content assessment system:
gathering metadata of content objects stored in the source repository;
processing unstructured content of the content objects to automatically extract targeted content of interest from the unstructured content;
interacting with a relational database to store the metadata of the content objects as structured data in a set of metadata fields of a relational content assessment database and store the targeted content of interest as structured data in a targeted content field of the relational content assessment database;
identifying a subset of content objects for transfer from the relational content assessment database;
mapping the gathered metadata for the subset of content objects from the relational content assessment database to target repository metadata; and
transferring the subset of content objects from the source repository to the target repository based on the relational content assessment database.

18. The method of claim 17, further comprising mapping targeted content of interest for the subset of content objects from the relational content assessment database to target repository metadata.

19. The method of claim 18, wherein:
the gathered metadata comprises file properties for the content objects; and
the set of metadata fields and the targeted content field corresponding to a particular content object are related to a primary key comprising an identification for that particular content object.

20. The method of claim 18, further comprising parsing the content of the content objects and pattern matching the content of the content objects to extract the targeted content of interest.

21. The method of claim 18, wherein transferring the subset of content objects further comprises copying the subset of content objects from the source repository to the target repository.

22. The method of claim 18, wherein transferring the subset of content objects further comprises a mass file transfer of the subset of objects.
